(19) United States
(12) Patent Application Publication
(10) Pub. No.: US 2025/0284654 A1
(43) Pub. Date: Sep. 11, 2025

(54) System for Multiple PCIe Hosts to Share SR-IOV Devices with Standard Host Drivers

(71) Applicant: Microchip Touch Solutions Limited, Wokingham (GB)

(72) Inventors: Atish Ghosh, Austin, TX (US); Pragash Mangalapandian, Chennai (IN); Annirudh D, Chennai (IN); Prasanna Vengateshan Varadharajan, Chennai (IN); Richard Cannon, Frodsham (GB); Ram Kumar Vellaldurai, Chennai (IN)

(73) Assignee: Microchip Touch Solutions Limited, Wokingham (GB)

(21) Appl. No.: 19/011,747

(22) Filed: Jan. 7, 2025

(30) Foreign Application Priority Data
Mar. 8, 2024 (IN) 202411016879

(51) Int. Cl. G06F 13/42

(52) U.S. Cl. CPC G06F 13/4221; G06F 2213/0026

(57) ABSTRACT

An apparatus includes a plurality of upstream PCIe ports, each connecting to a host, and a downstream PCIe port connecting to a Single Root I/O Virtualization (SR-IOV) device shared by the hosts. The apparatus provides access to virtual functions (VFs) of the SR-IOV device associated with a physical function (PF). A control circuit enumerates the SR-IOV device in an internal PCIe partition, emulates a first VF as a first individual PCIe device to a first host connected through a first upstream PCIe port, emulates a second VF as a second individual PCIe device to a second host connected through a second upstream PCIe port, and implements inter-domain bridging of PCIe transactions between the hosts and the VFs of the SR-IOV device.

### PRIORITY

The present disclosure claims priority to Indian Application No. 202411016879 filed Mar. 8, 2024, the contents of which are hereby incorporated in their entirety.

### TECHNICAL FIELD

The present disclosure relates to electronic devices such as computers sharing device resources and, more particularly, to a system for multiple Peripheral Component Interconnect Express (PCIe) hosts to share Single Root Input/Output Virtualization (SR-IOV) devices with standard host drivers.

### BACKGROUND

For multiple PCIe hosts to share SR-IOV devices, some solutions may use complex virtual intermediary software running on a given host, or a complex fabric mode switch which supports and manages an interconnect of multiple PCIe switches and devices to multiple hosts.

For example, one solution is to use Microchip Switchtec PAX Advanced Fabric PCIe Switch. PAX Fabric switches can be over-featured and cost prohibitive in some applications and it involves more computing resources including RAM, translation tables and proprietary routing of PCIe transactions.

In another example, there might be specialized software running on each host. This software is sometimes referred to as a Virtual Intermediary (VI). The VI software makes sure the processors of the various hosts work cooperatively, and that one host does not interfere with the operation of others. The VI software for a given operating system (OS) is unique for that given OS that the VI software may be running upon. Thus, a version of the VI software may be needed for every OS that might be used in various hosts sharing the SR-IOV device. Since behavior is based on cooperation, if one processor of a first host fails and writes into the space of a processor of a second host, problems may ensue.

Examples of the present disclosure may address one or more of these issues.

### BRIEF DESCRIPTION OF THE FIGURES

FIG. 1 is an illustration of an apparatus hosts to share a SR-IOV device to hosts simultaneously, according to examples of the present disclosure.

FIG. 2 is an illustration of operation of the apparatus to configure and manage physical functions and provide access to virtual functions associated with the physical function in a SR-IOV device, according to examples of the present disclosure.

FIG. 3 is an illustration of operation of the apparatus to emulate virtual functions as individual PCIe devices to hosts to share a SR-IOV device to hosts simultaneously, according to examples of the present disclosure.

FIG. 4 is an illustration of the apparatus to provide access to additional PCIe devices for hosts, according to examples of the present disclosure.

FIG. 5 is an illustration of operation of a control circuit to bridge requests from a given SR-IOV device, according to examples of the present disclosure.

FIG. 6 is an illustration of operation of the control circuit to handle communication from a given host, according to examples of the present disclosure.

FIG. 7 is another illustration of operation of the control circuit to handle communication from a given host, according to examples of the present disclosure.

FIG. 8 is an illustration of operation of the control circuit to handle communication from a respective virtual function, according to examples of the present disclosure.

FIG. 9 is another illustration of operation of the control circuit to handle communication from a respective virtual function, according to examples of the present disclosure.

FIG. 10 is a more detailed illustration of a bridge, according to examples of the present disclosure.

FIG. 11 is an illustration of an example method, according to examples of the present disclosure.

FIG. 12 is an illustration of an example article of manufacture and an example method performed by such an article of manufacture, according to examples of the present disclosure.

FIG. 13 is an illustration of a method that may be a more detailed illustration of the method of FIG. 12, according to examples of the present disclosure.

FIG. 14 is an illustration of operation of the control circuit to handle configuration read requests from a given host to a logical virtual function, according to examples of the present disclosure.

FIG. 15 is an illustration of operation of the control circuit to handle configuration write requests from a given host to a logical virtual function, according to examples of the present disclosure.

### SUMMARY

According to an aspect of the present disclosure, an apparatus is provided. The apparatus includes a plurality of upstream PCIe ports, a given upstream PCIe port to connect to a given host of a plurality of hosts. The apparatus includes a first downstream PCIe port to connect to a Single Root I/O Virtualization (SR-IOV) device, the SR-IOV device to be shared by the plurality of hosts, the apparatus to provide access to a plurality of virtual functions (VF) of the SR-IOV device associated with a physical function (PF) of the SR-IOV device. The apparatus includes a control circuit configured to enumerate the SR-IOV device in a PCIe partition internal to the apparatus. The control circuit is configured to emulate a first VF of the plurality of VFs as a first individual PCIe device to a first host of the plurality of hosts, the first host connected to the apparatus through a first upstream PCIe port of the upstream PCIe ports. The control circuit is configured to emulate a second VF of the plurality of VFs as a second individual PCIe device to a second host of the plurality of hosts, the second host connected to the apparatus through a second upstream PCIe port of the upstream PCIe ports. The control circuit is configured to implement inter-domain bridging of PCIe transactions between the plurality of hosts and the plurality of VFs of the SR-IOV device.

According to other aspects of the present disclosure, the apparatus may include one or more of the following features. The control circuit may be configured to configure and manage the PF and provide access to the VFs associated with the PF of the SR-IOV device. The control circuit may be configured to emulate the first and second VFs as the first and second individual PCIe devices, respectively, to the hosts to share the SR-IOV device to the hosts simultaneously. The control circuit may emulate the first and second VF as the first and second individual PCIe devices, respectively, to the hosts to share the SR-IOV device to the hosts simultaneously while indicating to a given one of the hosts that the given host has exclusive control over a given VF. The control circuit may be configured to provide non-transparent access to the SR-IOV device for the plurality of hosts through the VFs.

The first host may be configured to access the first upstream PCIe port in a first partition of the apparatus. The second host may be configured to access the second upstream PCIe port in a second partition of the apparatus. The control circuit may be configured to access the SR-IOV device from a third partition of the apparatus, the third partition the PCIe internal partition, wherein the first partition, the second partition, and the third partition of the apparatus are separate partitions. The first host may be configured to access a second downstream PCIe port in the first partition of the apparatus to access a downstream device. The control circuit may be configured to implement an inter-domain PCIe bridge to route PCIe signals between a given host to a respective given VF through the third partition. The control circuit may be configured to bridge or emulate configuration access requests from a given host to a respective given VF through the third partition.

The control circuit may be configured to determine whether a request originating from the SR-IOV device is from the PF or from one of the plurality of the VFs. Based on a determination that the request originating from the SR-IOV device is from one of the plurality of VFs, the control circuit may bridge the request to a respective host. Otherwise, based on a determination that the request originating from the SR-IOV device is from the PF, the control circuit may handle the request within the third partition. The control circuit may be configured to do one or more of: determine a first requester identifier and a first completer identifier of a first transaction layer packet (TLP) to bridge a configuration access request from the given host of the plurality of hosts to a respective VF in the third partition; determine a memory address, a second requester identifier, and a second completer identifier of a second TLP to bridge a first memory access, a first message, and a first completion from the given host of the plurality of hosts to the respective VF in the third partition; determine a third requester identifier of a third TLP to bridge a second memory access and a second message from the respective VF to the given host of the plurality of hosts in the third partition; and determine a fourth requester identifier and a third completer identifier of a fourth TLP to bridge a second completion from the respective VF to the given host of the plurality of hosts in the third partition.

The control circuit may handle a configuration read request from a given host to a respective LVF through: determination of whether requested configuration data is to be based on input from one or more of a local storage, or a PF, or a respective VF based on a configuration register address in the configuration read request; perform one or more of: retrieve configuration emulation data stored from a local storage for processing in a data processor based on the determination that the requested configuration data needs input from local storage; retrieve PF configuration data from PF for processing in data processor based on the determination that the requested configuration data needs input from PF; and retrieve VF configuration data from respective VF for processing in data processor based on the determination that the requested configuration data needs input from respective VF; and process one or more of configuration emulation data, PF configuration data, VF configuration data in the data processor and return processed configuration data for multi-host emulation of the SR-IOV device to the given host, bridging through the respective LVF; and update NTB rules.

The control circuit may handle a configuration write request from a given host to a respective LVF through: determination of whether configuration data is to be written based on input from one or more of a local storage, or a PF, or a respective VF based on a configuration register address in the configuration write request; perform one or more of: retrieve configuration emulation data stored from a local storage for processing in a data processor based on the determination that the configuration data to be written needs input from local storage; retrieve PF configuration data from PF for processing in data processor based on the determination that the configuration data to be written needs input from PF; and retrieve VF configuration data from respective VF for processing in data processor based on the determination that the configuration data to be written needs input from respective VF; and process one or more of configuration emulation data, PF configuration data, VF configuration data in the data processor to yield processed configuration data; write the processed configuration data to one or more of local storage, PF, and respective VF if the configuration register address addresses a valid register supported by respective LVF; and use processed configuration data for multi-host emulation of the SR-IOV device to the given host, bridging through the respective LVF; return completion status to the given host through the respective LVF; and update NTB rules.

According to another aspect of the present disclosure, an article of manufacture is provided. The article of manufacture includes instructions, the instructions, when loaded and executed by a processor, cause the processor to enumerate a Single Root I/O Virtualization (SR-IOV) device in a PCIe partition internal to an apparatus, the apparatus to include a plurality of upstream PCIe ports, a given upstream PCIe port to connect to a given host of a plurality of hosts, and a first downstream PCIe port to connect to the SR-IOV device, the SR-IOV device to be shared by the plurality of hosts, the apparatus to provide access to a plurality of virtual functions (VF) of the SR-IOV device associated with a physical function (PF) of the SR-IOV device. The instructions cause the processor to emulate a first VF of the plurality of VFs as a first individual PCIe device to a first host of the plurality of hosts, the first host connected to the apparatus through a first upstream PCIe port of the upstream PCIe ports. The instructions cause the processor to emulate a second VF of the plurality of VFs as a second individual PCIe device to a second host of the plurality of hosts, the second host connected to the apparatus through a second upstream PCIe port of the upstream PCIe ports. The instructions cause the processor to program an inter-domain PCIe bridging rule table to provide non-transparent access between the SR-IOV device and the plurality of hosts through the VFs. The instructions cause the processor to bridge configuration access requests from a given host to a respective given VF through a third partition. The instructions cause the processor to emulate configuration data for configuration access requests from a given host. The instructions cause the processor to manage inter-domain bridging of PCIe transactions between the plurality of hosts and the VF of the SR-IOV device.

According to other aspects of the present disclosure, the article of manufacture may include one or more of the following features. The instructions may cause the processor to configure and manage the PF and provide access to the VFs associated with the PF of the SR-IOV device. The instructions may cause the processor to emulate the first and second VFs as the first and second individual PCIe devices, respectively, to the hosts to share the SR-IOV device to the hosts simultaneously. The instructions may cause the processor to emulate the first and second VF as the first and second individual PCIe devices, respectively, to the hosts to share the SR-IOV device to the hosts simultaneously while indicating to a given one of the hosts that the given host has exclusive control over a given VF. The instructions may cause the processor to program the inter-domain PCIe bridging rule table to provide non-transparent access to the SR-IOV device for the plurality of hosts through the VFs.

The first host may be configured to access the first upstream PCIe port in a first partition of the apparatus. The second host may be configured to access the second upstream PCIe port in a second partition of the apparatus. The instructions may cause the processor to access the SR-IOV device from a third partition of the apparatus, wherein the first partition, the second partition, and the third partition of the apparatus are separate partitions. The instructions may cause the processor to program and manage an inter-domain PCIe bridge to route PCIe signals between a given host to a respective given VF through the third partition.

The instructions may cause the processor to do one or more of: (A) determine whether a request originating from the SR-IOV device is from the PF or from one of the plurality of the VFs; based on a determination that the request originating from the SR-IOV device is from one of the plurality of VFs, bridging the request to a respective host; and otherwise, based on a determination that the request originating from the SR-IOV device is from the PF, handling the request within the third partition; or (B) determine a first requester identifier and a first completer identifier of a first transaction layer packet (TLP) to bridge a configuration access request from the given host of the plurality of hosts to a respective VF in the third partition.

The instructions may cause the processor to handle a configuration read request from a given host to a respective LVF through: determination of whether requested configuration data is to be based on input from one or more of a local storage, or a PF, or a respective VF based on a configuration register address in the configuration read request; perform one or more of: retrieve configuration emulation data stored from a local storage for processing in a data processor based on the determination that the requested configuration data needs input from local storage; retrieve PF configuration data from PF for processing in data processor based on the determination that the requested configuration data needs input from PF; and retrieve VF configuration data from respective VF for processing in data processor based on the determination that the requested configuration data needs input from respective VF; and process one or more of configuration emulation data, PF configuration data, VF configuration data in the data processor and return processed configuration data for multi-host emulation of the SR-IOV device to the given host, bridging through the respective LVF; and update NTB rules.

The instructions may cause the processor to handle a configuration write request from a given host to a respective LVF through: determination of whether configuration data to be written is to be based on input from one or more of a local storage, or a PF, or a respective VF based on a configuration register address in the configuration write request; perform one or more of: retrieve configuration emulation data stored from a local storage for processing in a data processor based on the determination that the configuration data to be written needs input from local storage; retrieve PF configuration data from PF for processing in data processor based on the determination that the configuration data to be written needs input from PF; and retrieve VF configuration data from respective VF for processing in data processor based on the determination that the configuration data to be written needs input from respective VF; and process one or more of configuration emulation data, PF configuration data, VF configuration data in the data processor; write the processed configuration data to one or more of local storage, PF, and respective VF if the configuration register address addresses a valid register supported by respective LVF; and use processed configuration data for multi-host emulation of the SR-IOV device to the given host, bridging through the respective LVF; return a completion status to the given host through the respective LVF; and update NTB rules.

According to another aspect of the present disclosure, a method is provided. The method includes, at a PCIe switch: enumerating a Single Root I/O Virtualization (SR-IOV) device in a PCIe partition internal to an apparatus, the apparatus to include a plurality of upstream PCIe ports, a given upstream PCIe port to connect to a given host of a plurality of hosts, and a first downstream PCIe port to connect to the SR-IOV device, the SR-IOV device to be shared by the plurality of hosts, the apparatus to provide access to a plurality of virtual functions (VF) of the SR-IOV device associated with a physical function (PF) of the SR-IOV device. The method includes emulating a first VF of the plurality of VFs as a first individual PCIe device to a first host of the plurality of hosts, the first host connected to the apparatus through a first upstream PCIe port of the upstream PCIe ports. The method includes emulating a second VF of the plurality of VFs as a second individual PCIe device to a second host of the plurality of hosts, the second host connected to the apparatus through a second upstream PCIe port of the upstream PCIe ports. The method includes implementing inter-domain bridging of PCIe transactions between the plurality of hosts and the individual PCIe devices.

### DETAILED DESCRIPTION

The present disclosure relates to electronic device networking and, more particularly, to a system for multiple PCIe hosts to share SR-IOV devices with standard host drivers. The complexity of multiple hosts sharing input/output (I/O) devices may be abstracted in, for example, hardware (HW) and firmware (FW) implementations. A virtual intermediary software component might not be needed compared to other solutions.

Examples of the present disclosure may allow multiple PCIe host processors to share virtualized I/O devices, without using specialized host software, and without impacting data throughput. Compared to other solutions, this may provide a lower cost than a fabric-based switch. Furthermore, complex Virtual Intermediary software might not be required to be running on the host system.

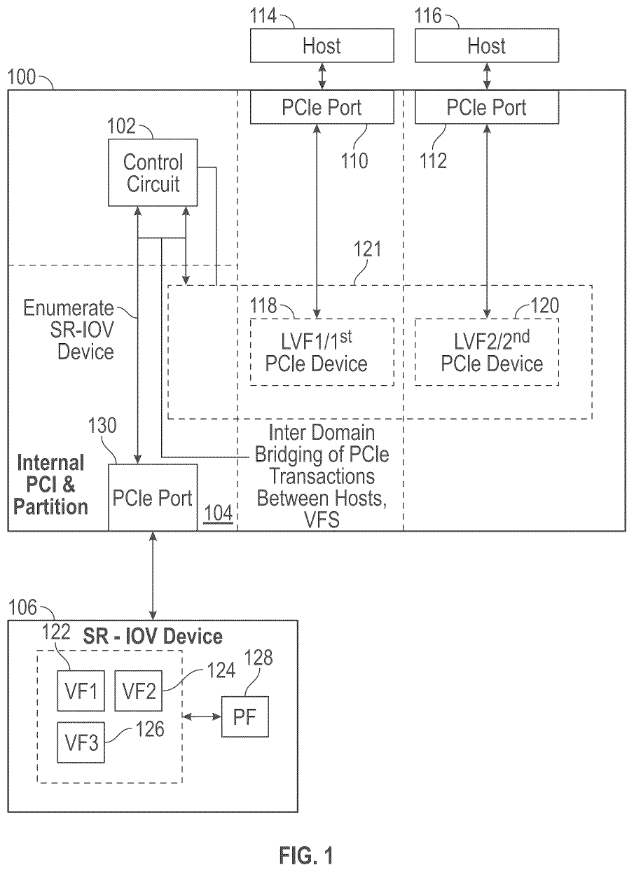

FIG. 1 is an illustration of an apparatus 100, according to examples of the present disclosure. Apparatus 100 may be implemented in any suitable manner, such as by a PCIe switch. Apparatus 100 may include a control circuit 102. Furthermore, apparatus 100 may include any suitable number and kind of PCIe ports 110, 112, 130. Apparatus 100 may be configured to connect to any suitable number and kind of PCIe hosts 114, 116. Apparatus 100 may be configured to share access to any suitable number and kind of SR-IOV device 106 to any suitable number and kind of hosts 114, 116. Although a single instance of SR-IOV device 106 is shown, and two hosts 114, 116 are shown in FIG. 1, any suitable number and kind of SR-IOV devices 106 and hosts 114, 116 may be used.

PCIe ports 110, 112, 130 may be configured in any suitable manner. PCIe ports 110, 112 may each be configured to connect to a given host among hosts 114, 116. PCIe ports 110, 112 may be upstream PCIe ports. PCIe port 130 may be configured to connect to SR-IOV device 106. PCIe port 130 may be a downstream PCI port.

Apparatus 100 may be configured to facilitate SR-IOV device 106 to be shared by hosts 114, 116. SR-IOV device 106 may include a physical function (PF) 128 and any suitable number and kind of virtual functions (VF) such as VF1 122, VF2 124, and VF3 126. The virtual functions may be functions that share one or more physical resources of PF 128. However, each virtual function may be separately assigned to an individual host such as hosts 114, 116, wherein each host understands or perceives that it is the sole operator of the corresponding PF 128 or device 106. By assigning different ones of virtual functions 122, 124, 126 to different hosts 114, 116, device 106 may effectively be shared by hosts 114, 116 even though such sharing of a SR-IOV device 106 across multiple PCIe hosts is not allowed under the PCIe specification.

Apparatus 100 may be configured to cause SR-IOV device 106 to be shared by hosts 114, 116. Specifically, such sharing may be enabled by control circuit 102. Control circuit 102 may be implemented in any suitable manner such as analog circuitry, digital circuitry, instructions for execution by a processor, a field programmable gate array, an application specific integrated circuit, programmable logic, an embedded processor, firmware, or any suitable combination thereof. Control circuit 102 may include or be communicatively coupled to an article of manufacture. The article of manufacture may be implemented as a non-transitory memory such as read only memory, random access memory, or any other suitable memory. The article of manufacture may include instructions. The instructions, when loaded and executed by a processor, may cause the processor to perform the operations of control circuit 102 as described in the present disclosure.

Control circuit 102 may be configured to provide interdomain bridging of PCIe transactions between hosts 114, 116 and virtual functions 122, 124, 126. An interdomain bridge 121 is illustrated in FIG. 1 for illustrative purposes, although such a bridge 121 may be implemented by different portions of control circuit 102 as described in subsequent figures.

Control circuit 102 may be configured to enumerate SR-IOV device 106 in a PCIe partition internal to apparatus 100 referred to as internal partition 104. Each of hosts 114, 116 may be assigned other partitions as described in subsequent figures. A given host may perceive only its assigned partition and activities and entities in other partitions may not be visible or transparent to such a host. In the example of FIG. 1, partition 104 might not be accessible or visible to either of hosts 114, 116. Port 130 may connect control circuit 102 to device 106 and partition 104.

Control circuit 102 may be configured to emulate a first virtual function such as VF1 122 as logical virtual function (LVF) LVF1 118 in a partition for host 114. Host 114 may perceive LVF1 118 as a first PCIe device that has attached to host 114 through port 110. Similarly, control circuit 102 may be configured to emulate a second virtual function such as VF2 124 as LVF2 120 in another partition assigned to host 116. Host 116 may perceive LVF2 120 as a second PCI device that has been attached to host 116 through port 112.

Example implementations of host 114 may be an x86 or ARM-based CPU with PCIe hosts. Examples of SR-IOV device 106 may include SR-IOV NVMe solid state drives (SSDs) or SR-IOPV network interface controllers (NICs).

In apparatus 100, each host 114, 116 may be given its own partition in apparatus 100. If a given host wants to access a virtualized I/O device such as device 106, in effect the given host must cross a partition boundary to a partition hosted by a different host-including SR-IOV device 106. Control circuit 102 may regulate access by host processors to other partitions that are accessed through virtual functions. Control circuit 102 may apply a set of rules to cross such a partition boundary. Some rule examples include translation of Requester ID in Transaction Layer Packets (TLPs), translation of Completer ID in TLPs, or translation of memory address in TLPs. Any suitable number and kind of rules can be used.

For each SR-IOV device, VFs may be assigned for each host as required. For example, such assignment may include that SR-IOV device 0 may have virtual functions 0 and 1 that are assigned to host 0; SR-IOV device 0 may have virtual functions 2 and 3 that are assigned to host 1; SR-IOV device 0 may have virtual functions 4, 5, 6 and 7 that are assigned to host 2; SR-IOV device 1 may have virtual functions 0, 1, 2, and 3 that are assigned to host 1; and SR-IOV device 1 may have virtual functions 4 and 5 that are assigned to host 0.

In one example, all data transactions may be handled in hardware by control circuit 102, with no impact on throughput. In one example, in firmware, all configuration transactions may be redirected by hardware in control circuit 102 to a hypervisor firmware running on an embedded processor. Such hypervisor firmware may be operating within or outside of control circuit 102. The hypervisor firmware may maintain the illusion that each host owns a PCIe device which is bridged to the respective VF. For example, if one host issue a ‘power down’ instruction to what it believes to be its device, the hypervisor firmware may respond with an acknowledgement but does nothing if other processors are still active.

Although a single SR-IOV device 106 and a single PF 128 therein are shown in FIG. 1, any suitable number of SR-IOV devices may be connected to apparatus 100 through respective downstream ports, and any suitable number of PFs may reside on a given SR-IOV device. SR-IOV devices may otherwise be configured to be connected to a single PCIe host and share the various functionalities of different virtual and physical functions to different operating systems running in virtualized environment in the same host. Examples of the present disclosure may allow multiple PCIe Hosts to share virtualized I/O devices, without using specialized host software in hosts 114, 116.

Control circuit 102 may utilize Non-Transparent Bridging (NTB), a inter domain bridging technique to support multiple partitions, an embedded CPU that runs a controller firmware that includes an embedded hypervisor firmware, and a multi host to single root virtual function bridge 121. Control circuit 102 may include these elements or may be communicatively coupled to these elements.

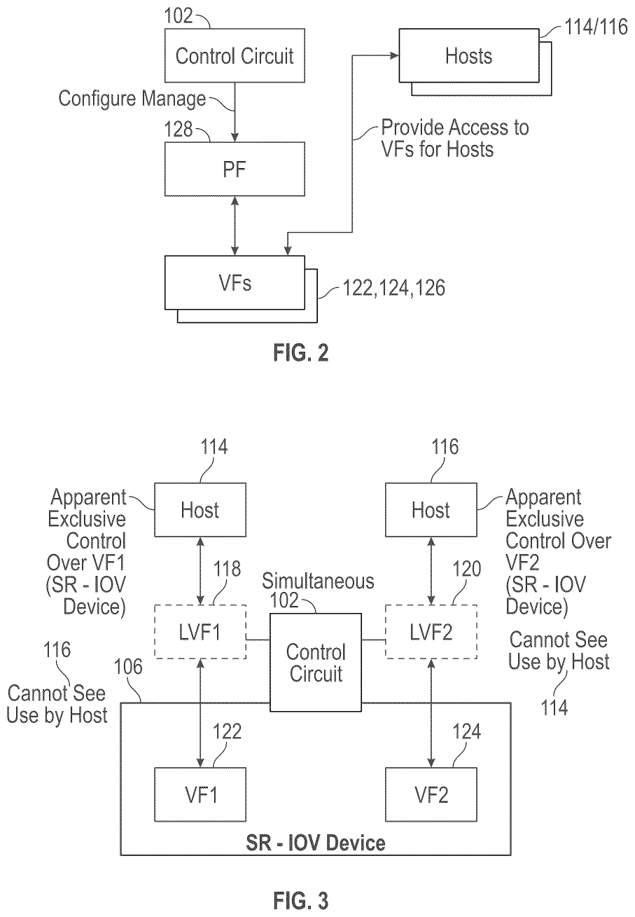

FIG. 2 is an illustration of operation of apparatus 100 to configure and manage PFs and provide access to VFs associated to the PF in the SR-IOV device 106, according to examples of the present disclosure.

Control circuit 102 may issue management or configuration commands to PF 128 of SR-IOV device 106. Such commands are discussed further below. Such commands may configure usage of different VFs 122, 124, 126 for use by various hosts 114, 116. Then, when access is requested of SR-IOV device 106 by hosts 114, 116, access to the perceived VFs 122, 124, 126 by hosts 114, 116 may be facilitated by control circuit 102.

FIG. 3 is an illustration of operation of apparatus 100 to emulate VFs as individual PCIe devices to hosts 114, 116 to share SR-IOV device 106 to hosts 114, 116 simultaneously, according to examples of the present disclosure.

Host 114 may have apparent exclusive control over VF1 122 through access of LVF1 118, which may represent a virtualized or emulated PCIe device by control circuit 102. LVF1 118 may be mapped to VF1 122 and SR-IOV device 106. Simultaneously, host 116 may have apparent exclusive control over VF2 124 through access of LVF2 120, which may represent a virtualized or emulated PCIe device by control circuit 102. LVF2 120 may be mapped to VF2 124 in SR-IOV device 106.

Host 114 might not be able to see the use or access of SR-IOV device 106 by host 116. Host 116 might not be able to see the use or access of SR-IOV device 106 by host 114. This may be accomplished through control circuit 102 emulating access of SR-IOV device 106 to hosts 114, 116 such that each of hosts 114, 116 perceive attachment of a PCIe device to its own downstream port with no visibility into other partitions. Control circuit 102 effectively indicates to each host 114, 116 believes that the respective host has exclusive control over a given VF in SR-IOV device 106. The access by a given host 114, 116 to SR-IOV device 106 is non-transparent to other hosts.

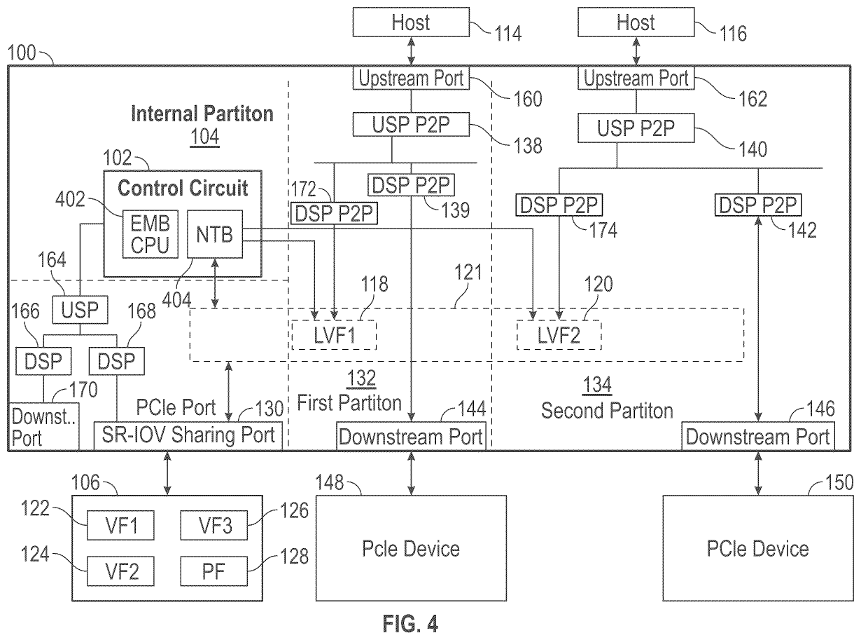

FIG. 4 is an illustration of apparatus 100 to provide access to additional PCIe devices for hosts 114, 116, according to examples of the present disclosure.

Host 114 may access upstream port 160 in a first partition 132 of apparatus 100, which may be connected to an upstream port (USP) PCI-to-PCI (P2P) bridge 138, which may be connected to a bus, which in turn may be connected to a downstream (DSP) P2P bridge 139 and DSP P2P 172.

Host 116 may access upstream PCIe port 112 in a second partition 134 of apparatus 100. PCIe port 110 may be implemented with a USP P2P 140, which may be connected to a bus, which may in turn be connected to a DSP P2P 142.

Control circuit 102 may access SR-IOV device from a third partition of apparatus 100, which may be PCIe internal partition 104. Partitions 104, 132, 134 may be separate partitions. Access to resources of other partitions may be made by bridge 121, controlled by control circuit 102.

Host 114 may access another downstream port 144, to which another downstream device such as PCIe device 148 may be connected. Access by host 114 to PCIe device 148 may be made through USP P2P bridge 138 to DSP P2P bridge 139 to downstream port 144.

Similarly, host 116 may access another downstream port 146, to which another downstream device such as PCIe device 150 may be connected. Access by host 116 to PCIe device 150 may be made through USP P2P bridge 140 to DSP P2P bridge 142 to downstream port 146.

Control circuit 102 may include or may be communicatively coupled to a non-transparent bridging circuit (NTB) 404 and an embedded central processing unit (CPU) 402. Embedded CPU 402 may be configured to run hypervisors, firmware, or any other suitable instructions. NTB circuit 404 may be implemented in any suitable manner such as analog circuitry, digital circuitry, instructions for execution by a processor, a field programmable gate array, an application specific integrated circuit, programmable logic, an embedded processor, firmware, or any suitable combination thereof. Operations of embedded CPU 402 may be performed by NTB circuit 404, and vice-versa, in different implementations. Embedded CPU 402 and NTB circuit 404 may implement bridge 121, and therein emulate VFs as LVF1 118 and LVF2 120.

Host 114 may connect to LVF1 118 through an upstream port 160 to USP P2P bridge 138 through a bus to DSP P2P 172. Access of LVF1 118 may in turn be routed through or by NTB circuit 404 to PCIe port 130 to SR-IOV device 106. This may be performed through an upstream port 164 and a downstream port 168. Moreover, routing of other data may be made through a DSP P2P 166 through a downstream port 170 to other elements. Similarly, host 116 may connect to LVF2 120 through upstream port 162 to USP P2P bridge 140 to a bus to DSP P2P 174. Access of LVF2 120 may in turn be routed through or by NTB circuit 404 to PCIe port 130 to SR-IOV device 106. PCIe signals may thus be routed by bridge 121 between a given host to a respective given VF through the third internal partition 104.

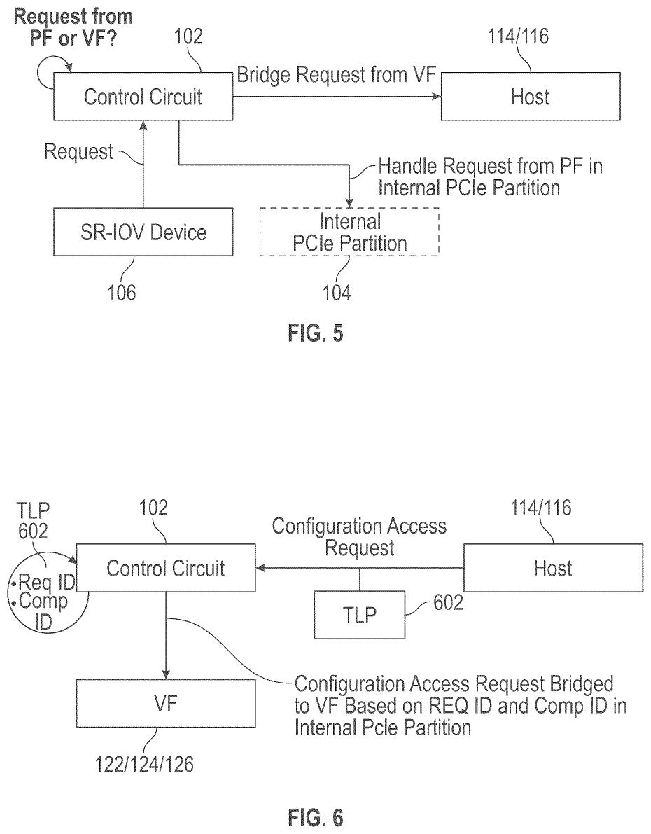

FIG. 5 is an illustration of operation of control circuit 102 to bridge requests from a given SR-IOV device 106, according to examples of the present disclosure.

Control circuit 102 may receive a request from SR-IOV device 106. Control circuit 102 may determine whether the request is from a PF or from one of the VFs associated with the PF. If it is from a VF, the request may be bridged to the respective host 114, 116 that is associated with the VF. If it is from a PF, the request may be handled by control circuit 102 in the third internal partition 104.

FIG. 6 is an illustration of operation of control circuit 102 to handle communication from a given host, according to examples of the present disclosure.

Control circuit 102 may receive a communication from a given host 114, 116. The request may include a transaction layer packet (TLP) 602, a configuration access request.

Control circuit 102 may determine a requester identifier and a completer identifier in the TLP, and use these to bridge the TLP, a configuration access request from the given host to a respective VF. This bridging may be performed through the third internal partition 104. A requester identifier may be a combination of a requesting host's bus number, device number, and function number. A completer identifier may be a combination of the completing host's bus number, device number, and function number.

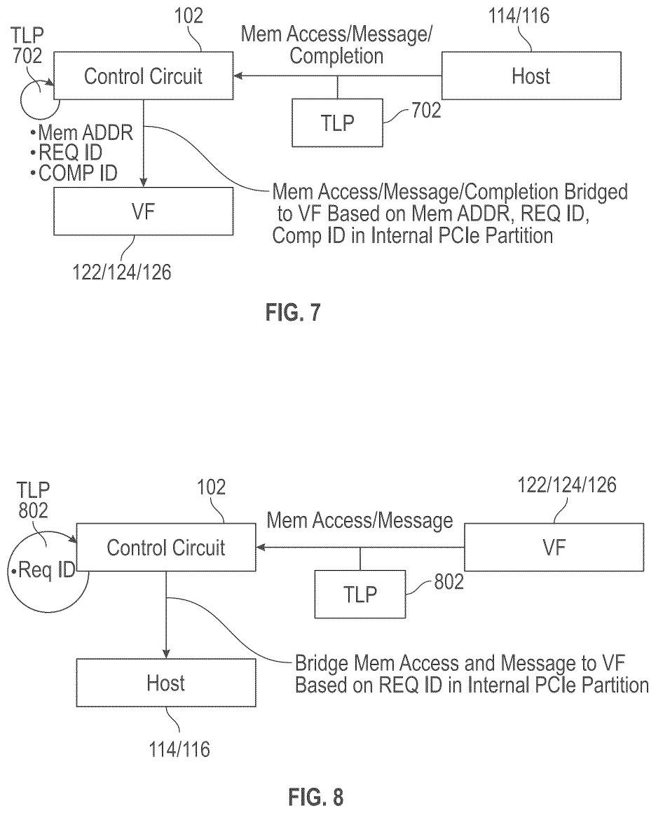

FIG. 7 is another illustration of operation of control circuit 102 to handle communication from a given host, according to examples of the present disclosure.

Control circuit 102 may receive a communication from a given host 114, 116. The request may include a TLP 702, a memory access request, message, or completion request.

Control circuit 102 may determine a memory address such as a specific location in the address space of a PCIe device, a requester identifier, and a completer identifier in the TLP, and use these to bridge the TLP, a memory access, message, or completion request from the given host to a respective VF. This bridging may be performed through the third internal partition 104.

FIG. 8 is yet another illustration of operation of control circuit 102 to handle communication from a respective VF 122, 124, 126, according to examples of the present disclosure.

Control circuit 102 may receive a communication from a given VF 122, 124, 126. The request may include a TLP 802, a memory access request or message.

Control circuit 102 may determine a requester identifier in the TLP, and use this to bridge the TLP, a memory access request or message from the given VF to a respective host. This bridging may be performed through the third internal partition 104.

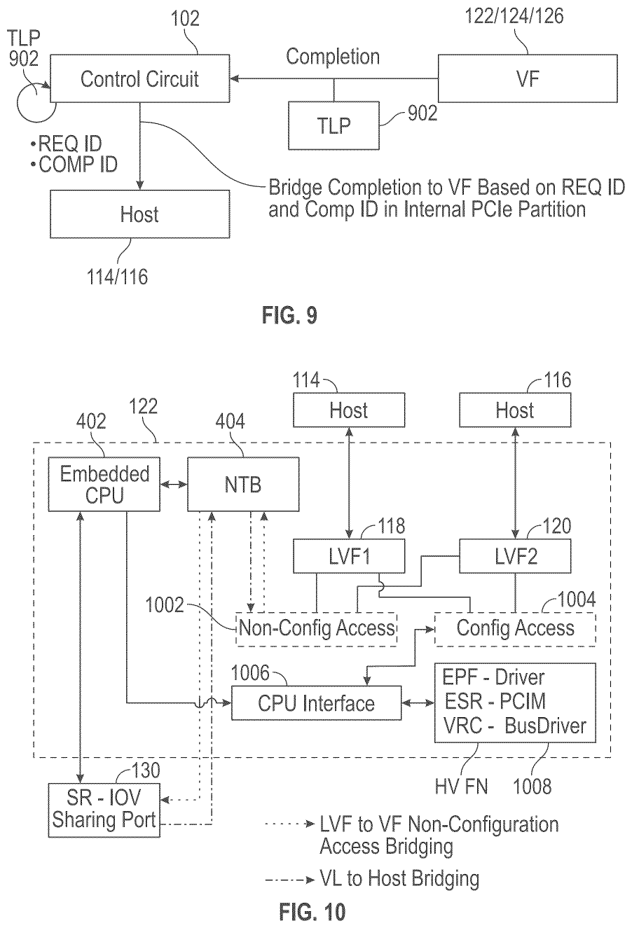

FIG. 9 is still yet another illustration of operation of control circuit 102 to handle communication from a respective VF 122, 124, 126, according to examples of the present disclosure.

Control circuit 102 may receive a communication from a given VF 122, 124, 126. The request may include a TLP 902, a completion request.

Control circuit 102 may determine a requester identifier and a completer identifier in the TLP, and use these to bridge the TLP, a completion request from the given VF to a respective host. This bridging may be performed through the third internal partition 104.

FIG. 10 is a more detailed illustration of bridge 121, according to examples of the present disclosure. Illustrated are requests for configuration access bridging from an LVF (and thus, an associated host 114, 116) to a respective VF, non-configuration access bridging from an LVF to a respective VF, and requests for VF to host bridging.

Requests from host 114 through LVF1 118 may be routed according to whether such requests are for configuration access 1004, a non-configuration access 1002, a memory access, message, or completion. Non-configuration access 1002 may be routed by NTB circuit 404 to SR-IOV sharing port 130 to SR-IOV device. Configuration access 1004 may be handled by hypervisor firmware (HV FW) 1008 running on embedded CPU 402. Configuration access 1004 may involve creation and submitting of configuration access TLPs to SR-IOV sharing port 130 to SR-IOV device, or bridging configuration access TLPs through NTB circuit 404 to SR-IOV sharing port 130 to SR-IOV device. Such requests may be handled through a CPU interface 1006 to embedded CPU 402. Configuration of apparatus 100 may be suitably performed as a result. Similarly, host 116 may access configuration access 1004 or non-configuration access 1002 through LVF2 120.

Hypervisor firmware 1008 may include an ePF driver, eSR-PCIM driver, and a vRC bus driver.

Control circuit 102 may perform the steps of first configuring specific ports of apparatus 100 for SR-IOV sharing functionality. Connection of the SR-IOV sharing port 130 may be made to internal partition 104, which is not directly connected to nor is directly visible to any of hosts 114, 116. Next, control circuit 102 may enumerate attached SR-IOV device 106 using the Virtual Root Complex bus driver (vRC-Bus driver) of HV FW 1008. Control circuit 102 may perform configuration and management of SR-IOV capable device 106. This may be performed through the embedded Single Root PCI-manager (eSR-PCIM) of HV FW 1008. Control circuit 102 may perform management of PFs such as PF 128 through embedded PF (ePF) driver of HV FW 1008. Control circuit 102 may then expose VFs as LVFs to any hosts such as hosts 114, 116 to which a given VF is to be shared. Control circuit 102 may then handle configuration access from hosts 114, 116 to the LVFs through a combination of forwarding requests to an associated PF, forwarding requests to respective VFs, and merging PF and VF data and emulation through, for example, operation of HV FW 1008. Control circuit 102 may set up and manage NTB rules for NTB circuit 404 to directly bridge requests such as DMA, memory space access and interrupt processing between a host and a VF (in a SR-IOV capable function), with reduced intervention from a CPU of apparatus 100.

As shown in FIG. 4, a given host 114, 116 may communicate with a given PCIe device 148, 150, or with SR-IOV device 106. Communication by a given host 114, 116 with a PCIe device 148, 150 attached to a same partition 132, 134 as the respective host 114, 116 may be referred to as a pass through mode of operation. Communication by a given host 114, 116 with a shared SR-IOV device 106 in a different partition such as partition 104, which is not connected to any external PCIe host and managed by a control circuit 102, may be referred to as an SR-IOV sharing mode.

The pass through mode of operation may be implemented according to the PCIe specification.

In the SR-IOV sharing mode, enumeration, resource allocation for memory space, interrupts, configuration, and power management of downstream devices such as SR-IOV device 106 may be managed and performed by control circuit 102, and in particular, HV FW 1008. Enumeration and configuration of PCIe devices in the SR-IOV sharing mode may be performed according to standard PCIe functions through an internal partition. PCIe endpoints with at least one SR-IOV capable function, such as SR-IOV device 106, may be supported at the respective downstream port such as port 130 as part of a standard PCIe function. When control circuit 102 detects unsupported PCIe devices (non-endpoints like switches and endpoints that do not have any SR-IOV capable function) at a DSP, the port operation may be switched from SR-IOV sharing mode to pass through mode, until disconnection of these devices, at which time the port is again switched to SR-IOV sharing mode.

In the SR-IOV sharing mode, bridge 121, under control of control circuit 102, may perform connections between LVFs 118, 120 between ports 138, 140 and port 130.

The vRC bus driver in HV FW 1008 may be a virtual root complex bus driver, and may be responsible for enumeration, resource allocation for memory space and interrupts, configuration, and power management of PCIe devices attached to the SR-IOV sharing port 130.

The eSR-PCIM may be an embedded single root PCI resource manager, and may be responsible for configuration and management of the SR-IOV extended capability and resources required by SR-IOV devices.

The ePF Driver may be an embedded physical function driver and may be responsible for PF management, enumeration of VFs, and management of all functions shared between the PFs and VFs.

LVFs 118, 120 may appear as PCIe devices to hosts 114, 116, and may be emulated by control circuit 102. LVFs 118, 120 may reflect the characteristics of the underlying VFs 122, 124, 126. Most of the transactions to LVFs 118, 120 are forwarded and bridged to SR-IOV device 106, targeting the specific VF 122, 124, 126.

LVF to VF bridging may be performed by control circuit 102. Specifically, configuration requests such as configuration read and configuration write requests from a given host 114, 116 to a given LVF 118, 120 may be bridged to SR-IOV device 106 through HV FW 1008 and NTB circuit 404. However, non-configuration accesses from a given host 114, 116 to a given LVF 118, 120 may be bridged to SR-IOV device 106 through NTB circuit 404, and may involve minimal involvement of HV FW 1008,

Communication between a given VF 122, 124, 126 to an associated LVF 118, 120, such as memory read and memory write requests from SR-IOV device 106, may be bridged to LVF 118, 120 through NTB circuit 404, and may involve minimal involvement of HV FW 1008.

In contrast, in a standard PCIe apparatus, for all the ports exposed to a given host, the related PCIe bus driver, SR-PCIM and PF Driver are usually implemented at each host.

In bridge 121, port 130 for SR-IOV 106 might not be exposed directly to any hosts 114, 116 outside of apparatus 100, and the vRC Bus driver, eSR-PCIM, ePF Driver components are implemented in HV FW 1008 in apparatus 100. The complexity of these elements and their operation is abstracted in apparatus 100 and only VFs 122, 124, 126 of SR-IOV device 106 are visible (and then, only emulated as LVFs) to hosts 114, 116 outside of apparatus 100.

HV FW 1008 may read the capabilities and memory space requirements of SR-IOV device 106, including the capabilities of VFs, and emulate an associated LVF per VF to be shared. A given LVF 118, 120 may be attached to a given host 114, 116 at boot time or run-time using PCIe hot plug capability.

The ePF driver may write the ‘System page size’ of a given PF 128 as 4 KB, as SR-IOV devices support 4 KB pages in ‘supported page sizes’. The ePF driver may calculate n Base Address Registers (BAR), given as LVF BAR0 . . . LVF BARn, based on the BAR0 . . . BARn register values read from PF 128 and the number of the VFs (n) and report the same to the respective host. LVFs 118, 120 might not report any I/O space requirements as part of the BARs, as I/O space might not be required by SR-IOV capable devices. Fields common to multiple or all VFs like error enable bits, Max_Payload_size, Max_read_request_size, etc. may be virtualized by HV FW 1008. The rest of a standard enumeration process per SR-IOV specification may be followed to enable the VFs from the PF.

LVF to VF configuration access bridging may also be handled by control circuit 102. Type 0 configuration read and configuration write requests from a given host 114, 116 to an associated LVF may be routed to HV FW 1008 for further processing and handling. It is up to HV FW 1008 to choose to read the entire 4 kilobytes of configuration data from the associated PF 128 and all associated VFs at boot time and store these for processing configuration requests, or otherwise read these on demand, when the related register of the LVF is accessed by a given host.

Depending on the LVF register address being read or written, control circuit 102 may forward the translated access request to the VF when all bits of a register are implemented in the VF, forward the translated access request to the PF if all bits of the register are implemented in the PF, forward the translated access request for bits implemented in VF and merge rest of the data from PF when the bits of the register are shared in PF and VF, or ignore configuration writes for features that are not applicable for VF or SR-IOV devices.

Wherever a configuration (implemented as registers or as bits of a register) that shared by all VFs is written by a given host, control circuit 102 may store the data being written to in a VF context specific manner, so that this data can be processed and returned when such configuration is read by the same host in a subsequent request. This is in contrast to, for example, actually writing the configuration information to a VF when it is not shared with other VFs.

LVFs 118, 120 may be implemented with command registers to store configuration information. When a memory space enable bit in the command register of a given LVF is set or cleared by a given host 114, 116, the NTB rules for memory access bridging may be updated.

When error enable bits in the command register of a given LVF is set or cleared by a host, NTB rules may be updated to allow or block error messages from the specific associated VF to a given respective host.

Link management commands and power management commands to a given LVF are handled primarily by HV FW 1008 as there is a single link upstream of SR-IOV device 106 and hence individual VFs 122, 124, 126 cannot be given access to control the link. The same may apply to power management capabilities, management, and handling.

For features that are supported by a PF or VF, but to which an associated LVF will not or cannot provide access, such capabilities are to be masked through altering next capability pointers to be updated as part of configuration data handling of the LVF.

Configuration access TLPs are routed through ID based routing, using bus number, device number, and function number (BDF) fields of TLP-based routing. When a given LVF configuration request needs to be forwarded to SR-IOV device 106, HV FW 1008 may translate a completer ID of the LVF (assigned in the domain of a given host) to the BDF of SR-IOV device 106 (as assigned by the vRC bus driver). Similarly, requester ID is to be translated across domain. Similarly, completer ID and requester IDs are also updated before returning completion data in response to a configuration read command.

LVF to VF non-configuration accesses may also be bridged by control circuit 102.

For memory TLP requests, such memory access TLPs may be routed based on address routing. For routing a memory access TLP addressed from a given host 114, 116 to a LVF 118, 120, to an internal partition 104 to a VF 122, 124, 126 in SR-IOV device 106, the NTB circuit 404 may be programmed as follows. NTB rules may be established to the translate the memory address in the incoming TLP, which are in the BAR range of the LVF, to the BAR range of the associated VF based on the ingress port 110, 112 of the memory access TLP. The ingress port is included along with the address in the translation since multiple hosts 114, 116 could have assigned the same BARs to the LVF 118, 120 visible to them.

Requester IDs may be translated from the host partition domain to that of the internal partition domain.

The NTB rules for memory access bridging are enabled or disabled based on a ‘memory space enable’ bit in command register of a given LVF. These rules are typically implemented in hardware to avoid overhead in TLP handling.

Completion TLPs may be routed based on ID routing. These may include completion without data, completion with data, completion for locked memory read without data, and completion for locked memory read with data. For routing a completion TLP addressed from given host 114, 116 to a LVF 118, 120, to internal partition 104 to a given VF 122, 124, 126 in SR-IOV device 106, NTB circuit 404 may be programmed as below. Based on the ingress port 110, 112 of the completion TLP, the completer ID may be translated from the domains of host partitions 132, 134 to that of the domain of internal partition 104.

Message TLPs may be routed by NTB circuit 404 as configured by HV FW 1008. However, power management message TLPs, including slot power limit messages, may be handled may be handled by HV FW 1008 as targeted to LVFs 118, 120 not bridged further when multiple VFs 122, 124, 126 are active, as multiple VFs 122, 124, 126 may share PF 128 and hence power management by individual VFs 122, 124, 126 might not be possible.

Vendor defined message TLPs may be translated from host domain partitions 132, 134 to internal partition 104.

Access from VFs 122, 124, 126 to LVFs 118, 120 and elements upstream thereof may be handled by control circuit 102.

Memory TLP bridging may be performed by control circuit 102. Memory requests typically originate from SR-IOV device 106 during bus master DMA transfers and MSI/MSI-X interrupts. Though memory TLPs are intended to be routed based on address, control circuit 102 may use the requester ID in the TLP to identify the VF 122, 124, 126 from which the request originated. For routing a memory access TLP from a given VF 122, 124, 126 to internal partition 104, to the upstream of a respective LVF 118, 120, NTB circuit 404 may be programmed as follows. In case the requester ID matches the BDF of PF 128, the memory read or write request is handled by the ePF-driver in HV FW 1008 and is not to be forwarded or bridged further. Otherwise, the memory read or memory write request is bridged to the LVF 118, 120 respective to host 114, 115 with which the VF 122, 124, 126 is bridged, with the requester ID field updated to that of the LVF 118, 120. Note that the address might not be translated, as DMA transfers are typically set up by programming the device DMA controller registers, which are accessible to a host (and the host driver) in the BAR space. The context of these DMA registers and the data that goes into these DMA registers might not be known to apparatus 100. Hence, though SR-IOV device 106 operates in the vRC domain, the DMA transfers (such as memory read requests) that SR-IOV device 106 initiates refer to the memory address of the actual host partition 132, 134 that it is connected to. Hence, the address might not be translated.

Control circuit 102 may bridge completion TLPs that originate from SR-IOV device 106 are based on the completer ID field in the completion header. For routing a completion TLP from a given VF to internal partition 104, to the upstream of LVF 118, 120, NTB circuit 404 may be programmed as follows. In case the completer ID matches the BDF of PF 128, the completion may be handled by the ePF-driver in HV FW 1008. Otherwise, the completion TLP may be bridged to the LVF 118, 120 respective to the host 114, 116 with which the VF 122, 124, 126 is bridged, with the completer ID field updated to that of the LVF 118, 120 and the requester ID field updated to that of the domain of the host internal partition 104 (as stored by LVF 118, 120).

Message TLPs bridging may be performed by NTB circuit 404 as configured by HV FW 1008.

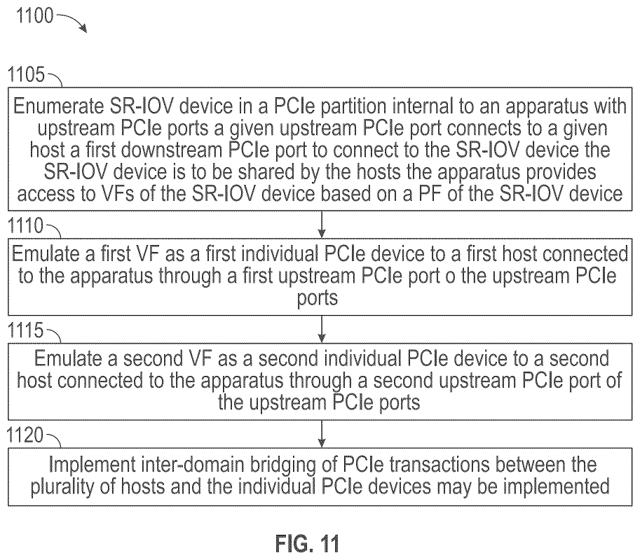

FIG. 11 is an illustration of an example method 1100, according to examples of the present disclosure. Method 1100 may begin at any suitable point. Method 1100 may include more or less steps than shown in FIG. 11. The steps of method 1100 may be performed in any suitable order, and steps of method 1100 may optionally be omitted, repeated, performed in parallel, or performed recursively. Method 1100 may be implemented by any suitable portion of FIGS. 1-10, such as apparatus 100 and in particular control circuit 102, HV FW 1008, and NTB circuit 404.

At 1105, an SR-IOV device may be enumerated in a PCIe partition internal to an apparatus. The apparatus may include a plurality of upstream PCIe ports, a given upstream PCIe port to connect to a given host of a plurality of hosts, and a first downstream PCIe port to connect to the SR-IOV device, wherein the SR-IOV device is to be shared by the plurality of hosts and the apparatus is to provide access to a plurality of VFs of the SR-IOV device based on PF of the SR-IOV device.

At 1110, a first VF of the plurality of VFs may be emulated as a first individual PCIe device to a first host of the plurality of hosts, wherein the first host is connected to the apparatus through a first upstream PCIe port of the upstream PCIe ports.

At 1115, a second VF of the plurality of VFs may be emulated as a second individual PCIe device to a second host of the plurality of hosts, the second host connected to the apparatus through a second upstream PCIe port of the upstream PCIe ports.

At 1120, inter-domain bridging of PCIe transactions between the plurality of hosts and the individual VFs may be implemented.

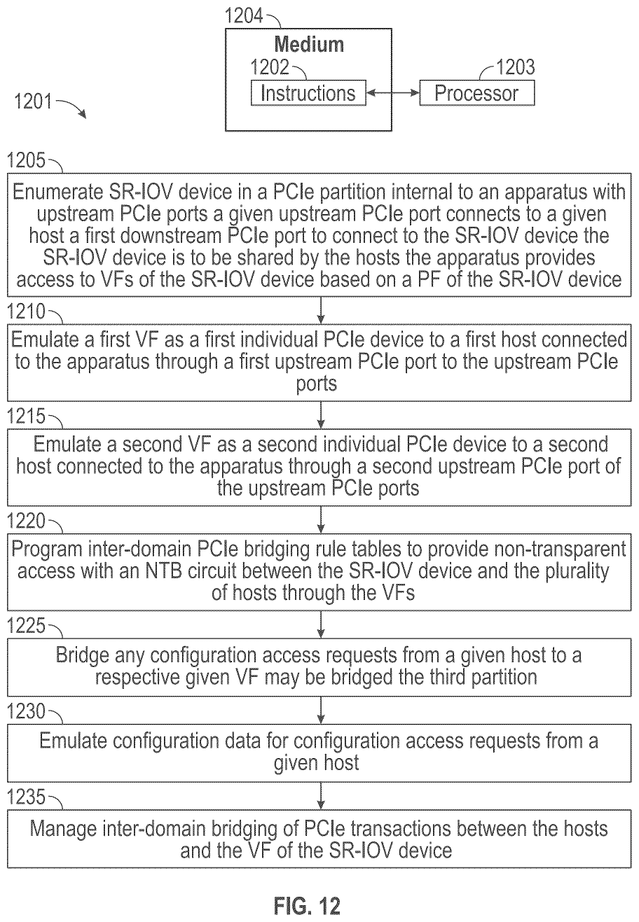

FIG. 12 is an illustration of an example article of manufacture 1200 and an example method 1201 performed by such an article of manufacture 1200, according to examples of the present disclosure. Article of manufacture 1200 may include a non-transitory machine-readable medium 1204 that may include instructions 1202, which when loaded and executed by a processor 1203, may perform any suitable operations of the present disclosure. Such operations may include method 1100, the operations of suitable portions of FIGS. 1-10 such as apparatus 100 and in particular control circuit 102, HV FW 1008, and NTB circuit 404, or a method 1201. Processor 1203 may be implemented by any suitable circuitry or processor such as embedded processor 402. Medium 1204 may be implemented in any suitable manner such as by a memory.

Method 1201 may be a more detailed illustration of method 1100. Method 1201 may begin at any suitable point. Method 1201 may include more or less steps than shown in FIG. 12. The steps of method 1200 may be performed in any suitable order, and steps of method 1201 may optionally be omitted, repeated, performed in parallel, or performed recursively. Method 1201 may be implemented by any suitable portion of FIGS. 1-10 and 12, such as apparatus 100 and in particular control circuit 102, HV FW 1008, and NTB circuit 404, or by processor 1203 executing instructions 1202.

At 1205, an SR-IOV device may be enumerated in a PCIe partition internal to an apparatus. The apparatus may include a plurality of upstream PCIe ports, a given upstream PCIe port to connect to a given host of a plurality of hosts, and a first downstream PCIe port to connect to the SR-IOV device, wherein the SR-IOV device is to be shared by the plurality of hosts and the apparatus is to provide access to a plurality of VFs of the SR-IOV device based on advertised capabilities within the PF of the SR-IOV device.

At 1210, a first VF of the plurality of VFs may be emulated as a first individual PCIe device to a first host of the plurality of hosts, wherein the first host is connected to the apparatus through a first upstream PCIe port of the upstream PCIe ports.

At 1215, a second VF of the plurality of VFs may be emulated as a second individual PCIe device to the first or second host of the plurality of hosts, the second host connected to the apparatus through a second upstream PCIe port of the upstream PCIe ports.

At 1220, inter-domain PCIe bridging rule tables may be programmed to provide non-transparent access between the SR-IOV device and the plurality of hosts through the VFs.

At 1225, any configuration access requests from a given host to a respective given VF may be bridged through the third partition.

At 1230, configuration data for configuration access requests from a given host may be emulated.

At 1235, inter-domain bridging of PCIe transactions between the plurality of hosts and the VF of the SR-IOV device may be managed as necessary.

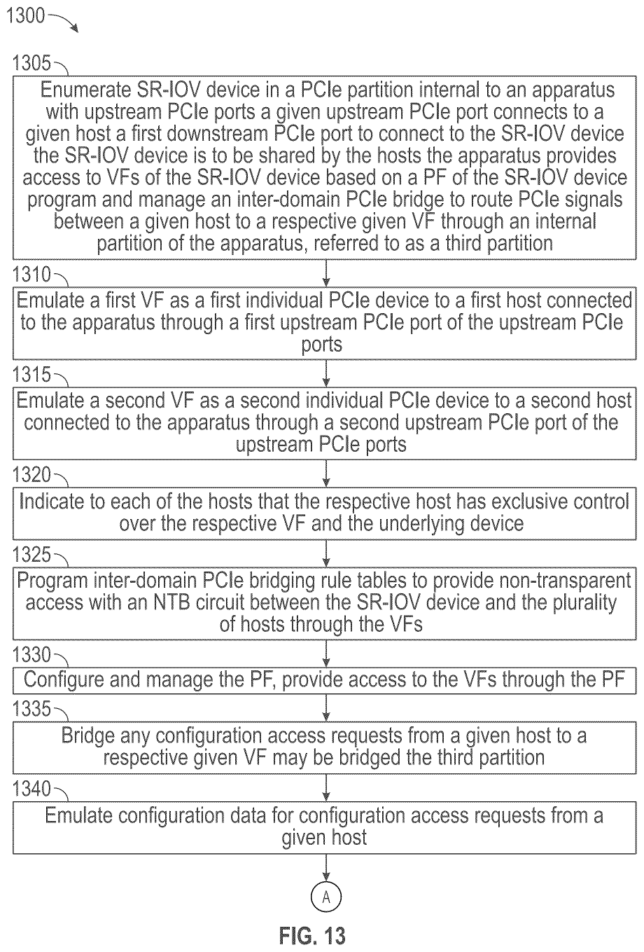

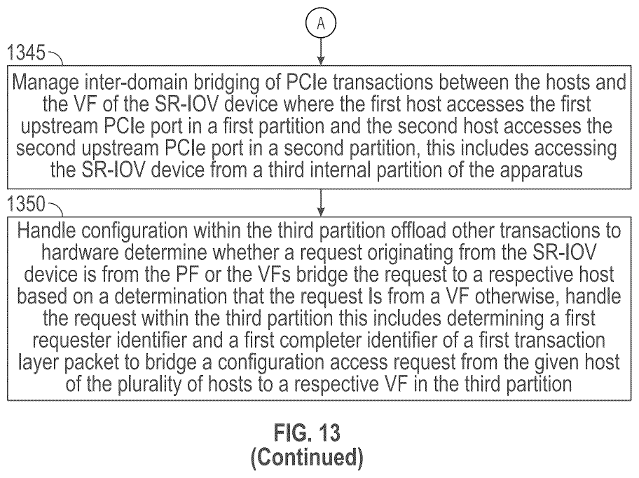

FIG. 13 is an illustration of a method 1300 that may be a more detailed illustration of method 1201, according to examples of the present disclosure.

At 1305, an SR-IOV device may be enumerated in a PCIe partition internal to an apparatus. The apparatus may include a plurality of upstream PCIe ports, a given upstream PCIe port to connect to a given host of a plurality of hosts, and a first downstream PCIe port to connect to the SR-IOV device, wherein the SR-IOV device is to be shared by the plurality of hosts and the apparatus is to provide access to a plurality of VFs of the SR-IOV device based on advertised capabilities within the PF of the SR-IOV device.

An inter-domain PCIe bridge may be programmed and managed to route PCIe signals between a given host to a respective given VF through an internal partition of the apparatus, referred to as a third partition.

At 1310, a first VF of the plurality of VFs may be emulated as a first individual PCIe device to a first host of the plurality of hosts, wherein the first host is connected to the apparatus through a first upstream PCIe port of the upstream PCIe ports.

At 1315, a second VF of the plurality of VFs may be emulated as a second individual PCIe device to a second host of the plurality of hosts, the second host connected to the apparatus through a second upstream PCIe port of the upstream PCIe ports. The VFs may be emulated as the devices to the hosts to share the SR-IOV device to the hosts simultaneously.

At 1320, indicate to each of the hosts that the respective host has exclusive control over the respective VF in the underlying device.

At 1325, inter-domain PCIe bridging rule tables may be programmed to provide non-transparent access between the SR-IOV device and the plurality of hosts through the VFs. This may include non-transparent access to the SR-IOV device for the plurality of hosts through the VFs.

At 1330, the PF may be configured and managed, and access to the VFs through the internal partition may be provided.

At 1335, any configuration access requests from a given host to a respective given VF may be bridged through the third partition after determining the configuration register address.

At 1340, configuration data for configuration access requests from a given host may be emulated after determining the configuration register address.

At 1345, inter-domain bridging of PCIe transactions between the plurality of hosts and the VF of the SR-IOV device may be managed as necessary. Where the first host is to access the first upstream PCIe port in a first partition of the apparatus and the second host is to access the second upstream PCIe port in a second partition of the apparatus, this may include accessing the SR-IOV device from a third partition of the apparatus, wherein the first partition, the second partition, and the third partition of the apparatus are separate partitions.

At 1350, such transactions may include configuration transactions that are handled within the third partition. Other transactions may be offloaded to hardware. Handling such transactions may include determining whether a request originating from the SR-IOV device is from the PF or from one of the plurality of the VFs, bridging the request to a respective host based on a determination that the request originating from the SR-IOV device is from one of the plurality of VFs, and otherwise, based on a determination that the request originating from the SR-IOV device is from the PF, handling the request within the third partition. Handling such transactions may include determining a first requester identifier and a first completer identifier of a first transaction layer packet to bridge a configuration access request from the given host of the plurality of hosts to a respective VF in the third partition.

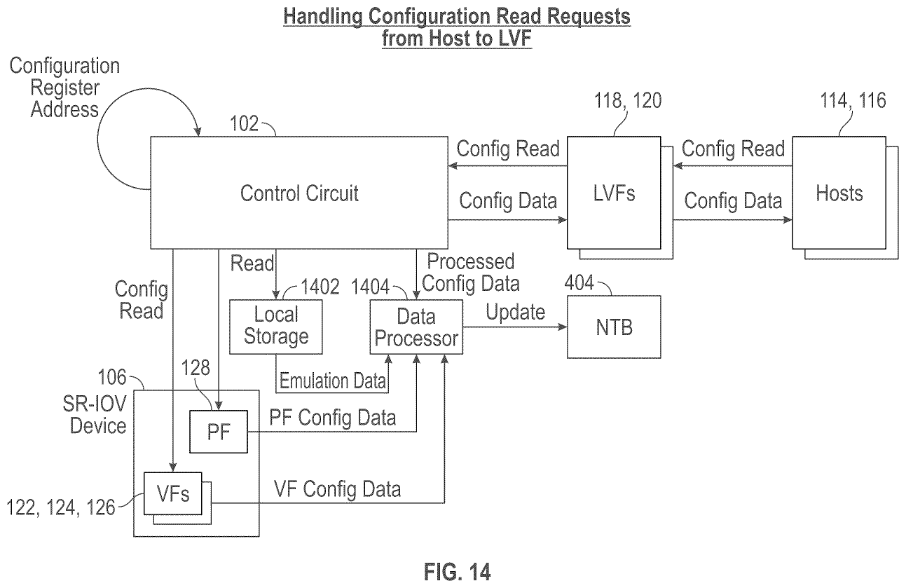

FIG. 14 is an illustration of operation of control circuit 102 to handle configuration read requests from a given host 114, 116 to a LVF 118, 120, according to examples of the present disclosure. Configuration read requests may include a transaction to read configuration registers of functions within devices.

One of hosts 114, 116 may issue a configuration request that is a read to an associated one of LVFs 118, 120.

The receiving LVF 118, 120 may provide the configuration read request to control circuit 102.

Control circuit 102 may be configured to determine from where the configuration read request will need input. For example, control circuit 102 may determine whether the requested configuration data needs input from one or more of a local storage 1402, PF 128, or a respective one of VFs 122, 124, 126. This determination may be based on the configuration register address of the configuration read requests.

If the configuration register address indicates that the configuration read request will need input from local storage, then control circuit 102 may retrieve configuration emulation data stored in local storage 1402 for processing in a data processor 1404.

If the configuration register address indicates that the configuration read request will need input from PF 128, then control circuit 102 may retrieve PF configuration data from PF 128 for processing in data processor 104.

If the configuration register address indicates that the configuration read request will need input from one of VFs 122, 124, 126, then control circuit 102 may retrieve VF configuration data from the identified one of VFs 122, 124, 126.

The input may be processed in data processor 1404. Processed configuration data may be returned to control circuit 102. Processed configuration data may be used for multi-host emulation of SR-IOV device 106, so that a given host 114, 116 may have its access bridged through the respective LVF 118, 120. NTB rules in NTB circuit 404 may be updated. Data processor 104 may apply arithmetic and logic operations on the data retrieved from one or more of local storage 1402, PF 128 and VFs 122,124,126 to finalize the processed configuration data.

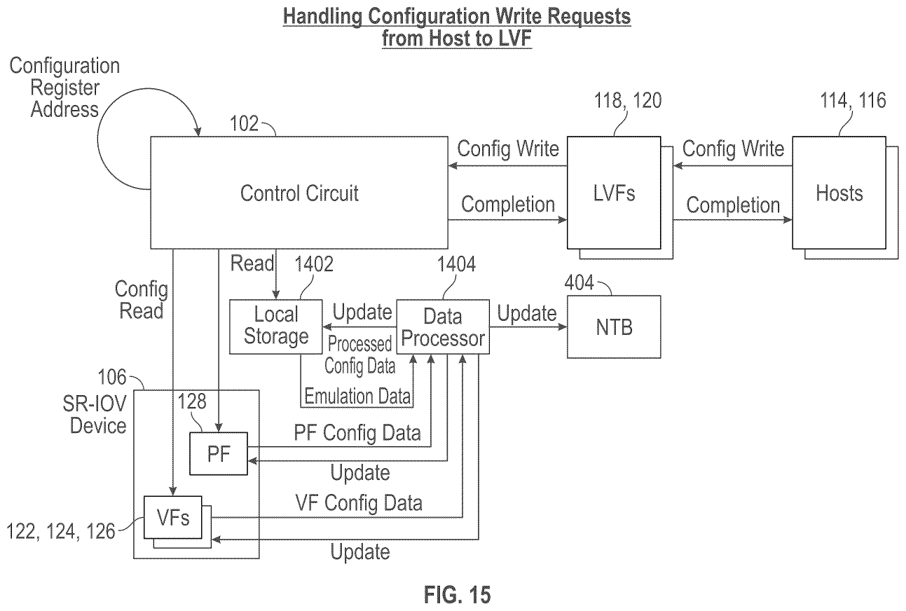

FIG. 15 is an illustration of operation of control circuit 102 to handle configuration write requests from a given host 114, 116 to a LVF 118, 120, according to examples of the present disclosure. Configuration write requests may include a transaction to write configuration registers of functions within devices.

One of hosts 114, 116 may issue a configuration request that is a write to an associated one of LVFs 118, 120.

The receiving LVF 118, 120 may provide the configuration write request to control circuit 102.

Control circuit 102 may be configured to determine from where the configuration write request will need input and to where the updated configuration data is to be written. For example, control circuit 102 may determine whether the requested configuration data write needs input from one or more of a local storage 1402, PF 128, or a respective one of VFs 122, 124, 126. This determination may be based on the configuration register address of the configuration read requests.

If the configuration register address indicates that the configuration write request will need input from local storage, then control circuit 102 may retrieve configuration emulation data stored in local storage 1402 for processing in a data processor 1404.

If the configuration register address indicates that the configuration write request will need input from PF 128, then control circuit 102 may retrieve PF configuration data from PF 128 for processing in data processor 104.

If the configuration register address indicates that the configuration write request will need input from one of VFs 122, 124, 126, then control circuit 102 may retrieve VF configuration data from the identified one of VFs 122, 124, 126.

The input may be processed in data processor 1404. Data processor 1404 may apply arithmetic and logic operations on the data retrieved from one or more of local storage 1402, PF 128 and VFs 122, 124, 128 to finalize the processed configuration data. Processed configuration data may be written to one or more of local storage 1402, PF 128 and VFs 122, 124, 126 if the configuration register address addresses a valid register supported by respective LVF. Processed configuration data may be used for multi-host emulation of SR-IOV device 106, so that a given host 114, 116 may have its access bridged through the respective LVF 118, 120. NTB rules in NTB circuit 404 may be updated. Control circuit 102 may return completion status to given host 114, 116 through the respective LVF 118, 120.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as non-transitory communications media and/or any combination of the foregoing.

Examples of the present disclosure may include an apparatus. The apparatus may include one or more upstream PCIe ports. A given upstream PCIe port may connect to a given host of one or more hosts. The apparatus may include a first downstream PCIe port to connect to a Single Root I/O Virtualization (SR-IOV) device. The SR-IOV device may be shared by the one or more hosts. The apparatus may provide access to one or more virtual functions (VFs) of the SR-IOV device associated with a physical function (PF) of the SR-IOV device. The apparatus may include a control circuit. The control circuit may be configured to enumerate the SR-IOV device in a PCIe partition internal to the apparatus. The control circuit may be configured to emulate a first VF of the VFs as a first individual PCIe device to a first host of the hosts. The first host may be connected to the apparatus through a first upstream PCIe port of the upstream PCIe ports. The control circuit may be configured to emulate a second VF of the VFs as a second individual PCIe device to a second host of the hosts. The second host may be connected to the apparatus through a second upstream PCIe port of the upstream PCIe ports. The control circuit may be configured to implement inter-domain bridging of PCIe transactions between the hosts and the VFs of the SR-IOV device. The control circuit may be implemented in any suitable manner, such as with analog circuitry, digital circuitry, a field programmable gate array, an application-specific integrated circuit, a programmable logic device, a microcontroller, a system on a chip, instructions for execution by a processor, or any suitable combination thereof.

In combination with any of the above examples, the control circuit may be configured to configure and manage the PF and provide access to the VFs associated with the PF of the SR-IOV device.

In combination with any of the above examples, the control circuit may be configured to emulate the first and second VFs as the first and second individual PCIe devices, respectively, to the hosts to share the SR-IOV device to the hosts simultaneously.

In combination with any of the above examples, the control circuit may emulate the first and second VF as the first and second individual PCIe devices, respectively, to the hosts to share the SR-IOV device to the hosts simultaneously while indicating to a given one of the hosts that the given host has exclusive control over a given VF.

In combination with any of the above examples, the control circuit may be configured to provide non-transparent access to the SR-IOV device for the hosts through the VFs.

In combination with any of the above examples, the first host may be configured to access the first upstream PCIe port in a first partition of the apparatus. The second host may be configured to access the second upstream PCIe port in a second partition of the apparatus. The control circuit may be configured to access the SR-IOV device from a third partition of the apparatus. The third partition may be the PCIe internal partition. The first partition, the second partition, and the third partition of the apparatus may be separate partitions.

In combination with any of the above examples, the first host may be configured to access a second downstream PCIe port in the first partition of the apparatus to access a downstream device.

In combination with any of the above examples, the control circuit may be configured to implement an inter-domain PCIe bridge to route PCIe signals between a given host to a respective given VF through the third partition.

In combination with any of the above examples, the control circuit may be configured to bridge or emulate configuration access requests from a given host to a respective given VF through the third partition.

In combination with any of the above examples, the control circuit may be configured to determine whether a request originating from the SR-IOV device is from the PF or from one of the VFs. Based on a determination that the request originating from the SR-IOV device is from one of the VFs, the control circuit may bridge the request to a respective host. Otherwise, based on a determination that the request originating from the SR-IOV device is from the PF, the control circuit may handle the request within the third partition.

In combination with any of the above examples, the control circuit may be configured to do one or more of: determine a first requester identifier and a first completer identifier of a first transaction layer packet (TLP) to bridge a configuration access request from the given host of the hosts to a respective VF in the third partition; determine a memory address, a second requester identifier, and a second completer identifier of a second TLP to bridge a first memory access, a first message, and a first completion from the given host of the hosts to the respective VF in the third partition; determine a third requester identifier of a third TLP to bridge a second memory access and a second message from the respective VF to the given host of the hosts in the third partition; and determine a fourth requester identifier and a third completer identifier of a fourth TLP to bridge a second completion from the respective VF to the given host of the hosts in the third partition.

In combination with any of the above examples, the control circuit may handle a configuration read request from a given host to a respective LVF through: determination of whether requested configuration data is to be based on input from one or more of a local storage, or a PF, or a respective VF based on a configuration register address in the configuration read request; perform one or more of: retrieve configuration emulation data stored from a local storage for processing in a data processor based on the determination that the requested configuration data needs input from local storage; retrieve PF configuration data from PF for processing in data processor based on the determination that the requested configuration data needs input from PF; and retrieve VF configuration data from respective VF for processing in data processor based on the determination that the requested configuration data needs input from respective VF; and process one or more of configuration emulation data, PF configuration data, VF configuration data in the data processor and return processed configuration data for multi-host emulation of the SR-IOV device to the given host, bridging through the respective LVF; and update NTB rules.

In combination with any of the above examples, the control circuit may handle a configuration write request from a given host to a respective LVF through: determination of whether configuration data is to be written based on input from one or more of a local storage, or a PF, or a respective VF based on a configuration register address in the configuration write request; perform one or more of: retrieve configuration emulation data stored from a local storage for processing in a data processor based on the determination that the configuration data to be written needs input from local storage; retrieve PF configuration data from PF for processing in data processor based on the determination that the configuration data to be written needs input from PF; and retrieve VF configuration data from respective VF for processing in data processor based on the determination that the configuration data to be written needs input from respective VF; and process one or more of configuration emulation data, PF configuration data, VF configuration data in the data processor to yield processed configuration data; write the processed configuration data to one or more of local storage, PF, and respective VF if the configuration register address addresses a valid register supported by respective LVF; and use processed configuration data for multi-host emulation of the SR-IOV device to the given host, bridging through the respective LVF; return completion status to the given host through the respective LVF; and update NTB rules.

Examples of the present disclosure may include an article of manufacture. The article of manufacture may include instructions. The instructions, when loaded and executed by a processor, may cause the processor to: enumerate a Single Root I/O Virtualization (SR-IOV) device in a PCIe partition internal to an apparatus. The apparatus may include: one or more upstream PCIe ports, a given upstream PCIe port to connect to a given host of one or more hosts; and a first downstream PCIe port to connect to the SR-IOV device. The SR-IOV device may be shared by the hosts. The apparatus may provide access to one or more virtual functions (VFs) of the SR-IOV device associated with a physical function (PF) of the SR-IOV device. The instructions may cause the processor to: emulate a first VF of the VFs as a first individual PCIe device to a first host of the hosts, the first host connected to the apparatus through a first upstream PCIe port of the upstream PCIe ports; emulate a second VF of the VFs as a second individual PCIe device to a second host of the hosts, the second host connected to the apparatus through a second upstream PCIe port of the upstream PCIe ports; program an inter-domain PCIe bridging rule table to provide non-transparent access between the SR-IOV device and the hosts through the VFs; bridge configuration access requests from a given host to a respective given VF through a third partition; emulate configuration data for configuration access requests from a given host; and manage inter-domain bridging of PCIe transactions between the hosts and the VF of the SR-IOV device. The instructions may be implemented in any suitable manner, such as with analog circuitry, digital circuitry, a field programmable gate array, an application-specific integrated circuit, a programmable logic device, a microcontroller, a system on a chip, instructions for execution by a processor, or any suitable combination thereof.

In combination with any of the above examples, the instructions may cause the processor to configure and manage the PF and provide access to the VFs associated with the PF of the SR-IOV device.

In combination with any of the above examples, the instructions may cause the processor to emulate the first and second VFs as the first and second individual PCIe devices, respectively, to the hosts to share the SR-IOV device to the hosts simultaneously.

In combination with any of the above examples, the instructions may cause the processor to emulate the first and second VF as the first and second individual PCIe devices, respectively, to the hosts to share the SR-IOV device to the hosts simultaneously while indicating to a given one of the hosts that the given host has exclusive control over a given VF.

In combination with any of the above examples, the instructions may cause the processor to program the inter-domain PCIe bridging rule table to provide non-transparent access to the SR-IOV device for the hosts through the VFs.

In combination with any of the above examples, the first host may be configured to access the first upstream PCIe port in a first partition of the apparatus. The second host may be configured to access the second upstream PCIe port in a second partition of the apparatus. The instructions may cause the processor to access the SR-IOV device from a third partition of the apparatus. The first partition, the second partition, and the third partition of the apparatus may be separate partitions.

In combination with any of the above examples, the instructions may cause the processor to program and manage an inter-domain PCIe bridge to route PCIe signals between a given host to a respective given VF through the third partition.

In combination with any of the above examples, the instructions may cause the processor to do one or more of: (A) determine whether a request originating from the SR-IOV device is from the PF or from one of the VFs; based on a determination that the request originating from the SR-IOV device is from one of the VFs, bridging the request to a respective host; and otherwise, based on a determination that the request originating from the SR-IOV device is from the PF, handling the request within the third partition; or (B) determine a first requester identifier and a first completer identifier of a first transaction layer packet (TLP) to bridge a configuration access request from the given host of the hosts to a respective VF in the third partition.

In combination with any of the above examples, the instructions may cause the processor to handle a configuration read request from a given host to a respective LVF through: determination of whether requested configuration data is to be based on input from one or more of a local storage, or a PF, or a respective VF based on a configuration register address in the configuration read request; perform one or more of: retrieve configuration emulation data stored from a local storage for processing in a data processor based on the determination that the requested configuration data needs input from local storage; retrieve PF configuration data from PF for processing in data processor based on the determination that the requested configuration data needs input from PF; and retrieve VF configuration data from respective VF for processing in data processor based on the determination that the requested configuration data needs input from respective VF; and process one or more of configuration emulation data, PF configuration data, VF configuration data in the data processor and return processed configuration data for multi-host emulation of the SR-IOV device to the given host, bridging through the respective LVF; and update NTB rules.

In combination with any of the above examples, the instructions may cause the processor to handle a configuration write request from a given host to a respective LVF through: determination of whether configuration data to be written is to be based on input from one or more of a local storage, or a PF, or a respective VF based on a configuration register address in the configuration write request; perform one or more of: retrieve configuration emulation data stored from a local storage for processing in a data processor based on the determination that the configuration data to be written needs input from local storage; retrieve PF configuration data from PF for processing in data processor based on the determination that the configuration data to be written needs input from PF; and retrieve VF configuration data from respective VF for processing in data processor based on the determination that the configuration data to be written needs input from respective VF; and process one or more of configuration emulation data, PF configuration data, VF configuration data in the data processor; write the processed configuration data to one or more of local storage, PF, and respective VF if the configuration register address addresses a valid register supported by respective LVF; and use processed configuration data for multi-host emulation of the SR-IOV device to the given host, bridging through the respective LVF; return a completion status to the given host through the respective LVF; and update NTB rules.

Examples of the present disclosure may include a method. The method may include operations of any of the above examples. The method may be performed by any suitable elements, such as a PCIe switch, a control circuit, a processor, or an apparatus. The method may include, at a PCIe switch: enumerating a Single Root I/O Virtualization (SR-IOV) device in a PCIe partition internal to an apparatus. The apparatus may include: one or more upstream PCIe ports, a given upstream PCIe port to connect to a given host of one or more hosts; and a first downstream PCIe port to connect to the SR-IOV device. The SR-IOV device may be shared by the hosts. The apparatus may provide access to one or more virtual functions (VFs) of the SR-IOV device associated with a physical function (PF) of the SR-IOV device. The method may include emulating a first VF of the VFs as a first individual PCIe device to a first host of the hosts. The first host may be connected to the apparatus through a first upstream PCIe port of the upstream PCIe ports. The method may include emulating a second VF of the VFs as a second individual PCIe device to a second host of the hosts. The second host may be connected to the apparatus through a second upstream PCIe port of the upstream PCIe ports. The method may include implementing inter-domain bridging of PCIe transactions between the hosts and the individual PCIe devices.

Although the present disclosure has been described in detail, it should be understood that various changes, substitutions, and alterations can be made hereto without departing from the spirit and the scope of the disclosure as defined by the appended claims.

1. An apparatus, comprising:
a plurality of upstream PCIe ports, a given upstream PCIe port to connect to a given host of a plurality of hosts;
a first downstream PCIe port to connect to a Single Root I/O Virtualization (SR-IOV) device, the SR-IOV device to be shared by the plurality of hosts, the apparatus to provide access to a plurality of virtual functions (VF) of the SR-IOV device associated with a physical function (PF) of the SR-IOV device; and
a control circuit configured to:
enumerate the SR-IOV device in a PCIe partition internal to the apparatus;
emulate a first VF of the plurality of VFs as a first individual PCIe device to a first host of the plurality of hosts, the first host connected to the apparatus through a first upstream PCIe port of the upstream PCIe ports;
emulate a second VF of the plurality of VFs as a second individual PCIe device to a second host of the plurality of hosts, the second host connected to the apparatus through a second upstream PCIe port of the upstream PCIe ports; and
implement inter-domain bridging of PCIe transactions between the plurality of hosts and the plurality of VFs of the SR-IOV device.

2. The apparatus of claim 1, wherein the control circuit is configured to configure and manage the PF and provide access to the VFs associated with the PF of the SR-IOV device.

3. The apparatus of claim 1, wherein the control circuit is configured to emulate the first and second VFs as the first and second individual PCIe devices, respectively, to the hosts to share the SR-IOV device to the hosts simultaneously.

4. The apparatus of claim 1, wherein the control circuit is to emulate the first and second VF as the first and second individual PCIe devices, respectively, to the hosts to share the SR-IOV device to the hosts simultaneously while indicating to a given one of the hosts that the given host has exclusive control over a given VF.

5. The apparatus of claim 1, wherein the control circuit is configured to provide non-transparent access to the SR-IOV device for the plurality of hosts through the VFs.

6. The apparatus of claim 1, wherein:
the first host is configured to access the first upstream PCIe port in a first partition of the apparatus;
the second host is configured to access the second upstream PCIe port in a second partition of the apparatus; and
the control circuit is configured to access the SR-IOV device from a third partition of the apparatus, the third partition the PCIe internal partition, wherein the first partition, the second partition, and the third partition of the apparatus are separate partitions.

7. The apparatus of claim 6, wherein the first host is configured to access a second downstream PCIe port in the first partition of the apparatus to access a downstream device.

8. The apparatus of claim 6, wherein the control circuit is configured to implement an inter-domain PCIe bridge to route PCIe signals between a given host to a respective given VF through the third partition.

9. The apparatus of claim 6, wherein the control circuit is configured to bridge or emulate configuration access requests from a given host to a respective given VF through the third partition.

10. The apparatus of claim 6, wherein the control circuit is configured to:
determine whether a request originating from the SR-IOV device is from the PF or from one of the plurality of the VFs;
based on a determination that the request originating from the SR-IOV device is from one of the plurality of VFs, bridging the request to a respective host; and
otherwise, based on a determination that the request originating from the SR-IOV device is from the PF, handling the request within the third partition.

11. The apparatus of claim 6, wherein the control circuit is configured to do one or more of:
determine a first requester identifier and a first completer identifier of a first transaction layer packet (TLP) to bridge a configuration access request from the given host of the plurality of hosts to a respective VF in the third partition;
determine a memory address, a second requester identifier, and a second completer identifier of a second TLP to bridge a first memory access, a first message, and a first completion from the given host of the plurality of hosts to the respective VF in the third partition;
determine a third requester identifier of a third TLP to bridge a second memory access and a second message from the respective VF to the given host of the plurality of hosts in the third partition; and
determine a fourth requester identifier and a third completer identifier of a fourth TLP to bridge a second completion from the respective VF to the given host of the plurality of hosts in the third partition.

12. The apparatus of claim 6, wherein the control circuit is to handle a configuration read request from a given host to a respective LVF through:
determination of whether requested configuration data is to be based on input from one or more of a local storage, or a PF, or a respective VF based on a configuration register address in the configuration read request;
perform one or more of:
retrieve configuration emulation data stored from a local storage for processing in a data processor based on the determination that the requested configuration data needs input from local storage;
retrieve PF configuration data from PF for processing in data processor based on the determination that the requested configuration data needs input from PF; and
retrieve VF configuration data from respective VF for processing in data processor based on the determination that the requested configuration data needs input from respective VF; and
process one or more of configuration emulation data, PF configuration data, VF configuration data in the data processor and return processed configuration data for multi-host emulation of the SR-IOV device to the given host, bridging through the respective LVF; and
update NTB rules.

13. The apparatus of claim 6, wherein the control circuit is to handle a configuration write request from a given host to a respective LVF through:
determination of whether configuration data is to be written based on input from one or more of a local storage, or a PF, or a respective VF based on a configuration register address in the configuration write request;
perform one or more of:
retrieve configuration emulation data stored from a local storage for processing in a data processor based on the determination that the configuration data to be written needs input from local storage;
retrieve PF configuration data from PF for processing in data processor based on the determination that the configuration data to be written needs input from PF; and
retrieve VF configuration data from respective VF for processing in data processor based on the determination that the configuration data to be written needs input from respective VF; and
process one or more of configuration emulation data, PF configuration data, VF configuration data in the data processor to yield processed configuration data;
write the processed configuration data to one or more of local storage, PF, and respective VF if the configuration register address addresses a valid register supported by respective LVF; and
use processed configuration data for multi-host emulation of the SR-IOV device to the given host, bridging through the respective LVF;
return completion status to the given host through the respective LVF; and
update NTB rules.

14. An article of manufacture, comprising instructions, the instructions, when loaded and executed by a processor, cause the processor to:
enumerate a Single Root I/O Virtualization (SR-IOV) device in a PCIe partition internal to an apparatus, the apparatus to include:
a plurality of upstream PCIe ports, a given upstream PCIe port to connect to a given host of a plurality of hosts; and
a first downstream PCIe port to connect to the SR-IOV device, the SR-IOV device to be shared by the plurality of hosts, the apparatus to provide access to a plurality of virtual functions (VF) of the SR-IOV device associated with a physical function (PF) of the SR-IOV device;
emulate a first VF of the plurality of VFs as a first individual PCIe device to a first host of the plurality of hosts, the first host connected to the apparatus through a first upstream PCIe port of the upstream PCIe ports;
emulate a second VF of the plurality of VFs as a second individual PCIe device to a second host of the plurality of hosts, the second host connected to the apparatus through a second upstream PCIe port of the upstream PCIe ports;
program an inter-domain PCIe bridging rule table to provide non-transparent access between the SR-IOV device and the plurality of hosts through the VFs;
bridge configuration access requests from a given host to a respective given VF through a third partition;
emulate configuration data for configuration access requests from a given host; and
manage inter-domain bridging of PCIe transactions between the plurality of hosts and the VF of the SR-IOV device.

15. The article of claim 12, wherein the instructions are to cause the processor to configure and manage the PF and provide access to the VFs associated with the PF of the SR-IOV device.

16. The article of claim 12, wherein the instructions are to cause the processor to emulate the first and second VFs as the first and second individual PCIe devices, respectively, to the hosts to share the SR-IOV device to the hosts simultaneously.

17. The article of claim 12, wherein the instructions are to cause the processor to emulate the first and second VF as the first and second individual PCIe devices, respectively, to the hosts to share the SR-IOV device to the hosts simultaneously while indicating to a given one of the hosts that the given host has exclusive control over a given VF.

18. The article of claim 12, wherein the instructions are to cause the processor to program the inter-domain PCIe bridging rule table to provide non-transparent access to the SR-IOV device for the plurality of hosts through the VFs.

19. The article of claim 12, wherein:
the first host is configured to access the first upstream PCIe port in a first partition of the apparatus;
the second host is configured to access the second upstream PCIe port in a second partition of the apparatus; and
the instructions are to cause the processor to access the SR-IOV device from a third partition of the apparatus, wherein the first partition, the second partition, and the third partition of the apparatus are separate partitions.

20. The article of claim 17, wherein the instructions are to cause the processor to program and manage an inter-domain PCIe bridge to route PCIe signals between a given host to a respective given VF through the third partition.

21. The article of claim 17, wherein the instructions are to cause the processor to do one or more of:
(A) determine whether a request originating from the SR-IOV device is from the PF or from one of the plurality of the VFs;
based on a determination that the request originating from the SR-IOV device is from one of the plurality of VFs, bridging the request to a respective host; and
otherwise, based on a determination that the request originating from the SR-IOV device is from the PF, handling the request within the third partition; or
(B) determine a first requester identifier and a first completer identifier of a first transaction layer packet (TLP) to bridge a configuration access request from the given host of the plurality of hosts to a respective VF in the third partition.

22. The article of claim 17, wherein the instructions are to cause the processor to handle a configuration read request from a given host to a respective LVF through:
determination of whether requested configuration data is to be based on input from one or more of a local storage, or a PF, or a respective VF based on a configuration register address in the configuration read request;
perform one or more of:
retrieve configuration emulation data stored from a local storage for processing in a data processor based on the determination that the requested configuration data needs input from local storage;
retrieve PF configuration data from PF for processing in data processor based on the determination that the requested configuration data needs input from PF; and
retrieve VF configuration data from respective VF for processing in data processor based on the determination that the requested configuration data needs input from respective VF; and
process one or more of configuration emulation data, PF configuration data, VF configuration data in the data processor and return processed configuration data for multi-host emulation of the SR-IOV device to the given host, bridging through the respective LVF; and
update NTB rules.

23. The article of claim 17, wherein the instructions are to cause the processor to handle a configuration write request from a given host to a respective LVF through:
determination of whether configuration data to be written is to be based on input from one or more of a local storage, or a PF, or a respective VF based on a configuration register address in the configuration write request;
perform one or more of:
retrieve configuration emulation data stored from a local storage for processing in a data processor based on the determination that the configuration data to be written needs input from local storage;
retrieve PF configuration data from PF for processing in data processor based on the determination that the configuration data to be written needs input from PF; and
retrieve VF configuration data from respective VF for processing in data processor based on the determination that the configuration data to be written needs input from respective VF; and
process one or more of configuration emulation data, PF configuration data, VF configuration data in the data processor;
write the processed configuration data to one or more of local storage, PF, and respective VF if the configuration register address addresses a valid register supported by respective LVF; and
use processed configuration data for multi-host emulation of the SR-IOV device to the given host, bridging through the respective LVF;
return a completion status to the given host through the respective LVF; and
update NTB rules.

24. A method, comprising, at a PCIe switch:
enumerating a Single Root I/O Virtualization (SR-IOV) device in a PCIe partition internal to an apparatus, the apparatus to include:
a plurality of upstream PCIe ports, a given upstream PCIe port to connect to a given host of a plurality of hosts; and
a first downstream PCIe port to connect to the SR-IOV device, the SR-IOV device to be shared by the plurality of hosts, the apparatus to provide access to a plurality of virtual functions (VF) of the SR-IOV device associated with a physical function (PF) of the SR-IOV device;
emulating a first VF of the plurality of VFs as a first individual PCIe device to a first host of the plurality of hosts, the first host connected to the apparatus through a first upstream PCIe port of the upstream PCIe ports;
emulating a second VF of the plurality of VFs as a second individual PCIe device to a second host of the plurality of hosts, the second host connected to the apparatus through a second upstream PCIe port of the upstream PCIe ports; and
implementing inter-domain bridging of PCIe transactions between the plurality of hosts and the individual PCIe devices.
